(19) United States
(12) Patent Application Publication
(10) Pub. No.: US 2024/0375195 A1
(43) Pub. Date: Nov. 14, 2024

(54) CUTTING TOOL HAVING A MULTIPART CUTTING HEAD

(71) Applicant: ZECHA HARTMETALL-WERKZEUGFABRIKATION GMBH, Koenigsbach-Stein (DE)

(72) Inventor: Martin RUCK, Ispringen (DE)

(21) Appl. No.: 18/286,384

(22) PCT Filed: Apr. 23, 2021
(86) PCT No.: PCT/EP2021/060627

§ 371 Date: Oct. 11, 2023

(51) Int. Cl. B23C 5/10; B23B 51/00

(52) U.S. Cl. CPC B23C 5/10; B23B 51/009; B23B 2226/315; B23B 2240/08; B23C 2226/315; B23C 2240/08

(57) ABSTRACT

A tool blank (30) for a cutting tool (1), such as an end mill, drill or engraving tool, includes a tool shank (2) configured to be received in a rotating tool holder of a processing machine, and a cutting head blank (3) fixedly connected to the tool shank (2). The cutting head blank (3) includes multiple cutting head blank elements (5) fixedly connected to each other, preferably soldered to each other, and made of a high hardness material such as polycrystalline diamond. A cutting tool (1), such as an end mill, drill or engraving tool, has at least one tool cutting edge (15) that is defined on such a tool blank (30) and extends over multiple cutting head blank elements (5) that are fixedly connected to one another.

### TECHNICAL FIELD

The present invention relates to a tool blank as well as to a cutting tool having such a tool blank. Furthermore, the invention relates to a method for manufacturing a tool blank as well as a cutting tool. In particular, the invention relates to a cutting tool having a multi-part cutting head.

### BACKGROUND ART

Cutting tools are comprised of a tool shank that is made of steel or solid carbide. A cutting head is usually soldered onto the tool shank. One or more tool cutting edges are produced (e.g., machined, cut) on the cutting head, in particular by using a laser. Depending on the intended use of the cutting tool, different cutting materials are used for the cutting head.

High-hardness materials are used as cutting materials in cutting tools when high wear resistance, high process reliability and long tool life are required.

High hardness materials are materials that are higher in hardness than carbides and cutting ceramics. In particular, polycrystalline diamond (PCD), CVD thick-film diamond (CVD-D), binderless diamond (UltraDiamond), polycrystalline cubic boron nitride (CBN), monocrystalline diamond (MKD) and natural diamond are among the high hardness materials. The hardness HV of high hardness materials is usually in the range of 2000-10000 kg/mm².

High-hardness materials are expensive materials. For example, polycrystalline diamond is provided in so-called blanks for further processing and the blanks become disproportionately expensive with increasing volume. For this reason, the use of cutting tools having large cutting heads is associated with high costs. Moreover, the strength of the PCD blanks decreases with increasing volume.

A polycrystalline compact is known from WO 2005/025805 A1. This polycrystalline compact comprises a substrate having a first surface and a second surface. A first polycrystalline layer is attached to the first surface of the substrate and a second polycrystalline layer is attached to the second surface of the substrate. The compacts make possible an increased effective thickness of a tool. The compacts are manufactured using high pressure, high temperature processes.

U.S. Pat. No. 4,766,040 describes a temperature-resistant polycrystalline diamond body. The body comprises at least two different, homogeneous diamond layers that lie on each other and are separated by a metal-diffusion-barrier intermediate layer between each diamond layer.

A sintered body insert for cutting is described in U.S. Pat. No. 5,712,030. This sintered body insert comprises an intermediate layer, which is composed of at least one of cemented carbide, a ferrous metal, and a high melting point metal, and a first layer and a second layer, which are each composed of hard sintered bodies that contain cubic boron nitride or diamond and that are disposed on opposite sides respectively above and below with the intermediate layer therebetween. The first and second layers are bonded to the intermediate layer by sintering.

A diamond insert for use as a cutting tool is known from U.S. Pat. No. 5,205,684, in which a plurality of rod-shaped elements made of polycrystalline diamond (PCD) are disposed within a matrix body.

In DE 10 2017 107 101 A1 and DE 43 41 503 A1, cutting tools are described that include an insert, which is composed of a carbide carrier and a crystal structure such as PCD sintered thereon.

It is one-non limiting object of the present teachings to disclose techniques that enable a cutting tool having high wear resistance to be made at lower cost.

### SUMMARY OF THE DISCLOSURE

According to a first aspect of the present teachings, a tool blank for a cutting tool such as, for example, an end mill, drill or engraving tool, may comprise a tool shank configured to be received in a rotating tool holder of a processing machine and a cutting head blank fixedly connected thereto. The cutting head blank in turn comprises multiple cutting head blank elements, which are fixedly connected to one another, preferably soldered to one another, and are made of a high-hardness material such as, in particular, polycrystalline diamond.

One non-limiting concept underlying the present teachings is to initially connect to one another multiple individually-available low-cost cutting head blank elements made of a high-hardness material, e.g., by soldering, adhering, etc., and then to produce (e.g., machine, cut) one or more tool cutting edges on this multi-part cutting head blank in a known manner, e.g., by laser cutting. In other words, according to this aspect of the present teachings, multiple individual high-hardness material blanks such as PCD blanks are initially joined together to form a larger cutting head.

Because multiple individual cutting head blank elements are connected together, a large cutting head blank can be fabricated which, as compared to a cutting head blank of the same size made from only one cutting head blank element, avoids the above-mentioned disadvantages of increasing costs and decreasing strength with increasing volume. Furthermore, by connecting together multiple cutting head blank elements, cutting tools having longer cutting head blanks and correspondingly having long tool cutting edges can also be produced from a high-hardness material.

Tool cutting edges having any arbitrary cutting geometry can be produced (e.g., machined, cut) on the cutting head blank. Preferably, the cutting geometries are lasered. The tool cutting edges extend across multiple cutting head blank elements, i.e. in particular across joints between two interconnected cutting head blank elements, such as, e.g., two PCD blanks that are soldered together.

If the cutting head blank elements are connected together, for example, by a solder connection, then the solder connection preferably has a thickness in the range of 0.01 mm-0.02 mm.

High hardness materials within the meaning of this disclosure include, for example, polycrystalline diamond (PCD), CVD thick-film diamond (CVD-D), binderless diamond (UltraDiamond), polycrystalline cubic boron nitride (CBN), monocrystalline diamond (MKD), and natural diamond.

Cutting tools within the meaning of this disclosure are to be understood as encompassing, for example, end mills, drills, lathe tools, whirl thread cutters or styluses such as engraving tools. Moreover, polishing and smoothing tools are also to be understood as being encompassed by the term cutting tools within the meaning of this disclosure, in which one usually speaks of a profile contour instead of a tool cutting edge, which is accordingly to be subsumed in this disclosure within the meaning of the term “tool cutting edge”.

In an exemplary embodiment, the multiple cutting head blank elements of the tool blank are stacked on each other in multiple stacked columns that extend in the direction of the axis of rotation of the tool blank and that are disposed around the axis of rotation.

Adjacent cutting head blank elements within a stacked column abut against each other at an abutment surface and are connected to each other at this abutment surface. The cutting head blank elements can be formed such that adjacent cutting head blank elements form (have, define) a form-fit connection in the area of their abutment surface. Preferably, the cutting head blank elements are connected to each other at the abutment surfaces with a solder connection.

Within a stacked column, the individual cutting head blank elements can be rotationally offset relative to each other. Accordingly, the cutting head blank elements of a stacked column can be disposed rotationally offset at different angles around the axis of rotation of the cutting tool.

In another exemplary embodiment, a first cutting head blank element of one stacked column is disposed offset along the axis of rotation from an adjacent second cutting head blank element of another (adjacent) stacked column.

By disposing the cutting head blank elements with an offset, continuous joints within the cutting head blank can be avoided. Joints that extend along any planar interface through the entire cutting head blank are to be understood as continuous joints. Such continuous joints constitute a weak point of the cutting head blank. By disposing the cutting head blank elements with an offset, such continuous joints and thus weak points can be avoided.

In a stacked structure of the cutting head blank having two parallel stacked columns along the axis of rotation, an offset can be achieved in a simple manner by varying thicknesses of the cutting head blank elements in the direction of the axis of rotation.

By disposing the cutting head blank elements in such a manner, an abutment surface between the first cutting head blank element and a cutting head blank element of the first stacked column adjacent thereto is spaced apart by an offset V with respect to an abutment surface between the second cutting head blank element and a cutting head blank element of the second stacked column adjacent thereto.

In another exemplary embodiment of the tool blank, the offset is in the range of 20%-80% of a height (length), which is measured in the direction of the axis of rotation, of the first cutting head blank element or the second cutting head blank element.

A continuous joint face is reliably avoided by an offset of this magnitude.

According to another exemplary embodiment, a third cutting head blank element in a stacked column is disposed with respect to an adjacent fourth cutting head blank element of the same stacked column at a rotational offset angle about the axis of rotation.

Owing to such a rotational offset, an abutment surface between the third cutting head blank element and a cutting head blank element of another stacked column adjacent thereto is rotationally offset at a rotational offset angle with respect to an abutment surface between the fourth cutting head blank element and a cutting head blank element of the other stacked column adjacent thereto.

Owing to the rotational offset of the cutting head blank elements around the axis of rotation, an offset is created in the circumferential direction of the cutting head. Continuous joints within the cutting head blank can thus be avoided.

In another exemplary embodiment of the tool blank, the rotational offset angle is in the range of 10°-80°.

A continuous joint face is reliably avoided by an offset of this magnitude.

In another exemplary embodiment, the tool blank has a first stacked column and a second stacked column. The cutting head blank elements each have a semi-cylindrical shape and are disposed such that the cutting head blank (formed by multiple cutting head blank elements) has a cylindrical shape overall.

This is a simple and good (stable) stacked structure.

In another exemplary embodiment, the multiple cutting head blank elements of the cutting head blank are disposed in a single stacked column and have a cylindrical shape. Adjacent cutting head blank elements of the stacked column abut against each other at respective abutment surfaces and are connected to each other at these abutment surfaces.

Preferably, the cutting head blank elements are connected together at the abutment surfaces with a solder connection.

This embodiment constitutes a simple structure in which the cutting head blank is equipped only with cylindrical cutting head blank elements. Multiple cylindrical bodies are stacked on each other to form a large cylindrical body, and the cylindrical bodies are formed so that at least one tool cutting edge can be machined onto the outer circumferential surface. For example, the multiple cutting head blank elements are PCD blanks or cut PCD blanks.

In another exemplary embodiment, an abutment surface between two cutting head blank elements, which abut each another in the direction of the axis of rotation, has an angle of inclination with respect to the axis of rotation in the range of 75°-89° at least regionally.

The use of an angle of inclination avoids that a continuous joint face perpendicular to the axis of rotation will result. Owing to the angle of inclination, joints at a tool cutting edge are overlapped by other tool cutting edges along the circumference perpendicular to the axis of rotation. The joints are located at different heights of the cutting head blank measured along the axis of rotation. Thus, the joints of cutting head blank elements on the tool cutting edges are not all in a common plane that is perpendicular to the axis of rotation.

The abutment surfaces can have a continuous angle of inclination with respect to the axis of rotation. Furthermore, the abutment surfaces can also have areas with different angles of inclination with respect to the axis of rotation. For example, the abutment surfaces can be formed such that a conical elevation is formed that engages in a form-fit manner in a conical depression of an adjacent cutting head blank element that is formed as a mating shape. Any shapes can be used for manufacturing a form-fit between adjacent cutting head blank elements.

In another exemplary embodiment, the tool shank has a protruding pin on its end face to which the cutting head blank is attached. A bore or recess is formed in at least one cutting head blank element such that the bore or recess of the at least one cutting head blank element is attached to the pin of the tool shank in a form-fit manner.

The pin and the bore or recess in the cutting head blank element are matched to each other such that they can be placed on each other in a form-fit manner. In addition, the positioning of the cutting head blank elements is simplified by the bore and the pin. Preferably, the at least one cutting head blank element is attached to the pin with a solder connection. Owing to the pin, the strength is increased owing to a larger surface area for the solder. The pin can be used additionally in any of the described embodiments. For example, abutment surfaces that are formed in an angled manner for a form-fit connection of cutting head blank elements can additionally have a bore for a pin, by which the cutting head blank elements are connectable to the pin in a form-fit manner.

In another exemplary embodiment, the cutting head blank elements have a height (length), which is measured along the axis of rotation, in the range from 0.2 mm to 2 mm, preferably in the range from about 0.5 mm to 1.5 mm. The cutting head blank has a length (length), which is measured in the direction of the axis of rotation, in the range from 0.2 mm to 15 mm, preferably in the range from about 2 mm to 10 mm.

According to a second aspect of the present teachings, a cutting tool such as an end mill, drill or engraving tool is provided. In the cutting tool, at least one tool cutting edge, which extends across a plurality of the fixedly interconnected cutting head blank elements, is produced (e.g., machined, cut) on a tool blank according to the first aspect of the present teachings.

In such a cutting tool, the tool cutting edge is preferably lasered on the cutting head blank. By using a cutting head blank according to the present teachings, long cutting head blanks and thus long tool cutting edges can be realized. Of course, such cutting tools exhibit all the advantages of the tool blank according to the present teachings shown above.

In the context of the present disclosure, the term “cutting head blank element” is used to refer to both a cutting head blank element on which a tool cutting edge has not yet been produced (formed) as well as a cutting head blank element on which a tool cutting edge has been produced (formed). A cutting head blank on which a tool cutting edge has been produced also may be referred to as a “cutting head”.

In an exemplary embodiment of the cutting tool, the at least one tool cutting edge does not contact (extend across) an abutment surface between a cutting head blank element of the first stacked column and a cutting head blank element of the second stacked column.

The one or more tool cutting edges extend from the end of the cutting head, which is connected to the tool shank, to the terminal end of the cutting head. The abutment surfaces between a cutting head blank element of the first stacked column and a cutting head blank element of the second stacked column are coordinated with the path (contour) of the tool cutting edge such that the tool cutting edge does not cross such abutment surfaces. Weak points within the tool cutting edge are avoided thereby. The joints between cutting head blank elements are thus disposed in the non-cutting area(s) of the cutting tool.

Preferably, the tool cutting edges are disposed so that they are spaced at a distance of at least 0.01 mm from the abutment surfaces between a cutting head blank element of the first stacked column and a cutting head blank element of the second stacked column.

According to a third aspect of the present teachings, a method for manufacturing a cutting head blank for a cutting tool such as an end mill, drill or engraving tool is provided. Such a method may comprise the steps of providing multiple cutting head blank elements made of a high hardness material, such as in particular PCD blanks, and then fixedly connecting, preferably soldering, the multiple cutting head blank elements to a tool shank such that the interconnected cutting head blank elements form a cutting head blank that is fixedly connected to the tool shank.

Cutting head blank elements can be stacked on each other in various stacking structures in the manner already described above for the tool blank. The cutting head blank elements form the cutting head blank into which the at least one tool cutting edge is subsequently machined. The tool cutting edge is preferably machined into the cutting head blank by laser. Any shapes can be stacked on each other in the stacking structure as long as adjacent cutting head blank elements have a common abutment surface.

For example, a cylindrical shape or a ring shape can be cut out of the PCD blank. In embodiments in which the ring shape is selected, a small cylinder is cut out of a large cylinder. The ring-shaped cutting can be used for a first cutting tool or cutting head blank. The cylindrical-shaped cutout can be used for a second, smaller cutting tool or second cutting head blank.

In an exemplary embodiment of the method for manufacturing a cutting head blank, the step of fixedly connecting the multiple cutting head blank elements to a tool shank is performed by first connecting the cutting head blank elements to form the cutting head blank and then connecting the cutting head blank to the tool shank.

Such a process enables the spatially separated manufacture of the cutting head blank from the tool shank. That is, only after the cutting head blank has been produced is it connected to the tool shank.

In another exemplary embodiment of the method for manufacturing a cutting head blank, the step of fixedly connecting the multiple cutting head blank elements to a tool shank is performed by piece by piece connecting individual cutting head blank elements to the tool shank or to a cutting head blank element that is already connected to the tool shank.

This method makes it possible to use the tool shank as a guide and aid for the attachment and to connect the cutting head blank elements individually with a precise fit to, for example, the pin of the tool shank.

According to a fourth aspect of the present teachings, a method of manufacturing a cutting tool such as an end mill, drill or engraving tool is provided. This method comprises first manufacturing a cutting head blank according to the third aspect of this disclosure. Then, this method further comprises producing (e.g., machining, cutting) at least one tool cutting edge on the cutting head blank across multiple cutting head blank elements.

Cutting head blank elements according to the present disclosure can be cut, for example, by laser from the following commercially available round blanks:
PCD round blank from the company elementsix, Syndite, R70.0 mm/T 1.6 mm, KT-DP-CMX850,
PCD round blank from the company elementsix, Syndite, CTB R743-36007CPL010, 180-200-2330-01, and
CBN round blank from the company elementsix, Amborite, DBC50 R574-36008 002, 310-200-0353-01.

### BRIEF DESCRIPTION OF THE DRAWINGS

Exemplary embodiments of the present teachings are described and explained in more detail below with reference to the accompanying drawings.

FIG. 1 shows a side view of a cutting tool according to the present teachings.

FIG. 2 shows a sectional view of the cutting tool 1 shown in FIG. 1 along section A-A shown in FIG. 1.

FIG. 3 shows a front view of a tool blank according to the present teachings in accordance with a first embodiment.

FIG. 4 shows a sectional view of the tool blank shown in FIG. 3 along section B-B shown in FIG. 3.

FIG. 5 shows a sectional view of the tool blank shown in FIGS. 3 and 4 along section C-C shown in FIG. 4.

FIG. 6 shows a schematic view of the four tool cutting edges depicted in FIG. 5 in unrolled form and plotted one below the other.

FIG. 7 shows a perspective view from diagonally in front of the tool blank shown in FIGS. 3 to 5.

FIG. 8 shows a front view of a tool blank according to the present teachings in accordance with a second embodiment.

FIG. 9 shows a sectional view of the tool blank shown in FIG. 8 along section D-D shown in FIG. 8.

FIG. 10 shows two sectional views of the tool blank shown in FIG. 9 along sections E-E and F-F shown in FIG. 9.

FIG. 11 shows a sectional view of a cutting tool according to the present teachings perpendicular to the axis of rotation R.

FIG. 12 shows a sectional view of a tool blank according to the present teachings according to a fourth embodiment.

FIG. 13 shows a sectional view of a tool blank according to the present teachings according to a fifth embodiment.

FIG. 14 shows a sectional view of a tool blank according to the present teachings in accordance with a sixth embodiment.

FIG. 15 shows a sectional view of a tool blank according to the present teachings according to a seventh embodiment.

FIG. 16 shows a sectional view of the tool blank shown in FIG. 15 along section G-G shown in FIG. 14.

FIG. 17 is a sectional view of a tool blank according to the present teachings in accordance with an eighth embodiment.

### DETAILED DESCRIPTION

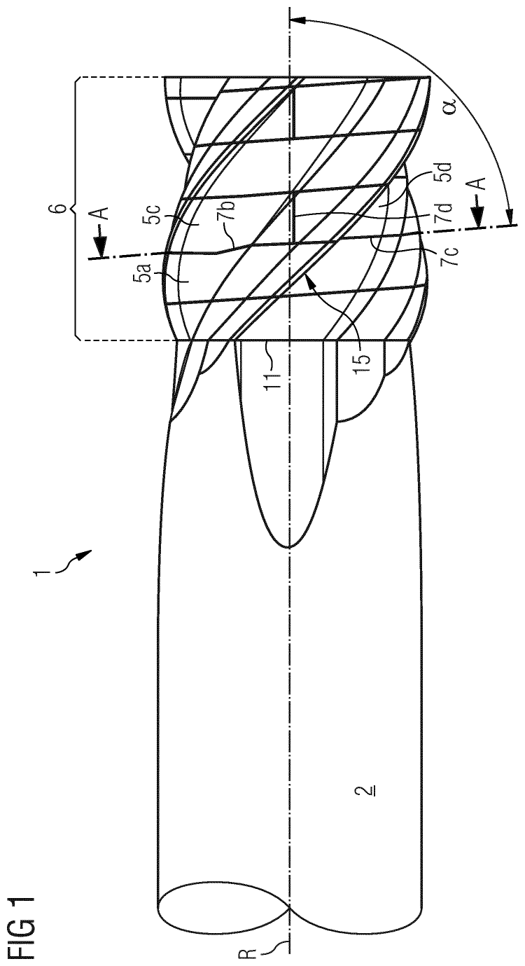

FIG. 1 shows a side view of a cutting tool 1 according to the present teachings in accordance with a first embodiment. A cutting head 6 is connected to a tool shank 2 at a shank joint 11. In use, the cutting tool 1 rotates about the axis of rotation R. The cutting head 6 is manufactured by producing (e.g., machining, cutting) tool cutting edges 15 on a cutting head blank 3. The cutting head blank 3 as such is thus no longer visible in FIG. 1. In other words, a cutting head blank 3 that has already been further processed into a cutting head 6 is shown in FIG. 1. The cutting head blank 3 is formed by a plurality of cutting head blank elements 5 that are stacked on each other. The cutting head blank elements 5 are stacked on each other in a stack-like structure. Adjacent cutting head blank elements 5 abut against each other at respective abutment surfaces 7. The cutting head blank elements 5 are no longer visible as such in FIG. 1. Cutting head blank elements 5 that have already been further processed are shown. In this disclosure, the term “cutting head blank element” is also used for the cutting head blank elements having a tool cutting edge that has been produced thereon.

Cutting head blank elements 5a, 5c, 5d are shown in an exemplary manner for the cutting head blank elements 5; in addition, abutment surfaces 7b, 7c, 7d are shown in an exemplary manner for the abutment surfaces 7. The cutting head blank element 5a abuts against the cutting head blank element 5c at the abutment surface 7b. Furthermore, the cutting head blank element 5a abuts against the cutting head blank element 5d at the abutment surface 7c. The cutting head blank elements 5c and 5d abut against each other at the abutment surface 7d.

Multiple tool cutting edges 15 extend across a plurality of the cutting head blank elements 5.

The multiple cutting head blank elements 5, which are fixedly connected to each other, are disposed in the direction of and around the axis of rotation R.

The abutment surfaces 7b, 7c are not perpendicular to the axis of rotation R, but rather are inclined at an angle α with respect to the axis of rotation R.

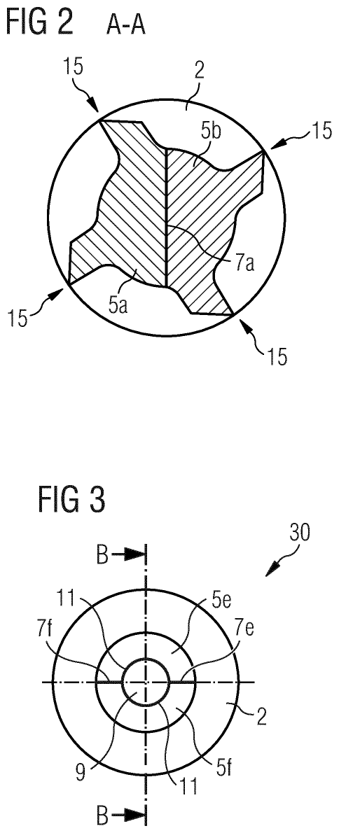

FIG. 2 shows a sectional view of the cutting tool 1 shown in FIG. 1 along section A-A. The section plane extends through the abutment surfaces 7b and 7c. The section plane is thus disposed at the angle αwith respect to the axis of rotation R. The abutment surfaces 7b, 7c abut against each other at the abutment surface 7a and are connected to each other there. Two tool cutting edges 15 are produced both on the outer circumference of the cutting head blank element 5a and on the outer circumference of the cutting head blank element 5b.

FIG. 3 shows a front view of a tool blank 30 according to the present teachings in accordance with a first embodiment.

No tool cutting edges 15 have yet been produced on the cutting head blank 3 shown in FIG. 3. A pin 9 is disposed on the tool shank 2. Two cutting head blank elements 5e, 5f are disposed one above the other on the pin 9. The cutting head blank elements 5e, 5f abut at the abutment surfaces 7e and 7f and are connected together. In addition, the cutting head blank elements 5e, 5f are connected to the pin 9 of the tool shank 2 at the shank joint 11.

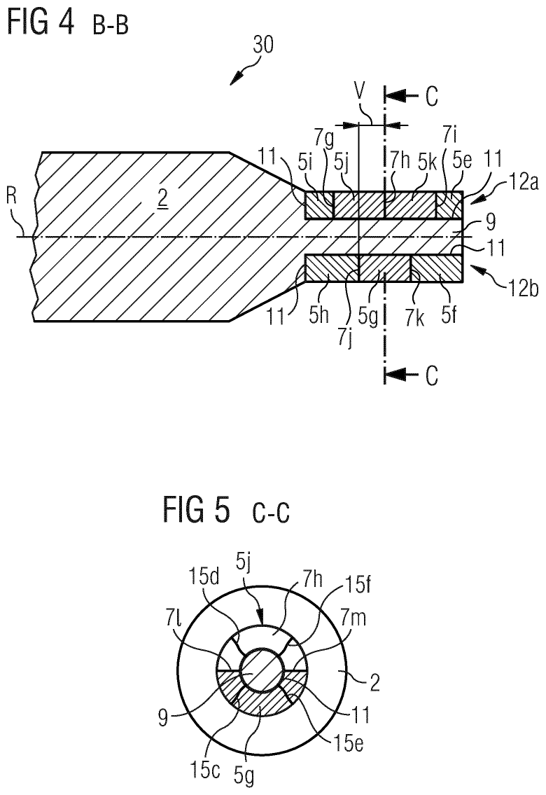

FIG. 4 is a sectional view of the tool blank 30 shown in FIG. 3 along the section B-B shown in FIG. 3. A total of seven cutting head blank elements 5e, 5f, 5g, 5h, 5i, 5j, 5k are disposed on the pin 9 of the tool shank 2. The two cutting head blank elements 5e, 5f that are disposed on the right side of the pin 9 are the cutting head blank elements 5e, 5f shown in FIG. 3.

The cutting head blank elements 5e, 5f, 5g, 5h, 5i, 5j, 5k abut on each other at the abutment surfaces 7g, 7h, 7i, 7j, 7k and are connected to each other there. The cutting head blank elements 5e, 5f, 5g, 5h, 5i, 5j, 5k are connected to the tool shank 2 or the pin 9 of the tool shank 2 at the shank joint 11. The cutting head blank elements 5e, 5i, 5j, 5k are stacked on each other in a first stacked column 12a in the direction of the axis of rotation R, and the cutting head blank elements 5f, 5g, 5h are stacked on each other in a second stacked column 12b in the direction of the axis of rotation R. The first stacked column 12a and the second stacked column 12b are disposed one above the other. The first stacked column 12a and the second stacked column 12b extend parallel to each other.

The cutting head blank elements 5e, 5i, 5j, 5k of the first stacked column 12a and the cutting head blank elements 5f, 5g, 5h of the second stacked column 12b are disposed in an offset manner from each other in the direction of the axis of rotation R. Accordingly, there is an offset V in the direction of the axis of rotation R between the abutment surfaces 7g, 7h, 7i of the first stacked column 12a and the abutment surfaces 7j, 7k of the second stacked column 12b. For example, the offset V between the abutment surfaces 7j and 7h is shown in FIG. 4.

FIG. 5 is a sectional view of the tool blank 30 shown in FIGS. 3 and 4 along the section C-C shown in FIG. 4. The cutting head blank element 5g having the shank joint 11 is attached to the pin 9 from below. On the upper half of the pin 9, the section extends exactly through the abutment surface 7h between the cutting head blank elements 5j and 5k. Thus, an end face of the cutting head blank element 5j is shown. The cutting head blank elements 5j and 5g abut against each other at the abutment surfaces 71, 7m and are connected with each other there. Furthermore, four tool cutting edges 15c-15f are illustrated. The depiction of the tool cutting edges 15c-15f corresponds to a front view onto the tool blank and not to the sectional view along section C-C. The tool cutting edges 15c-15f are illustrated in FIG. 5 merely as an example. In FIGS. 3, 4 and 7, which also show the first embodiment, the tool cutting edges 15c-15f are not illustrated.

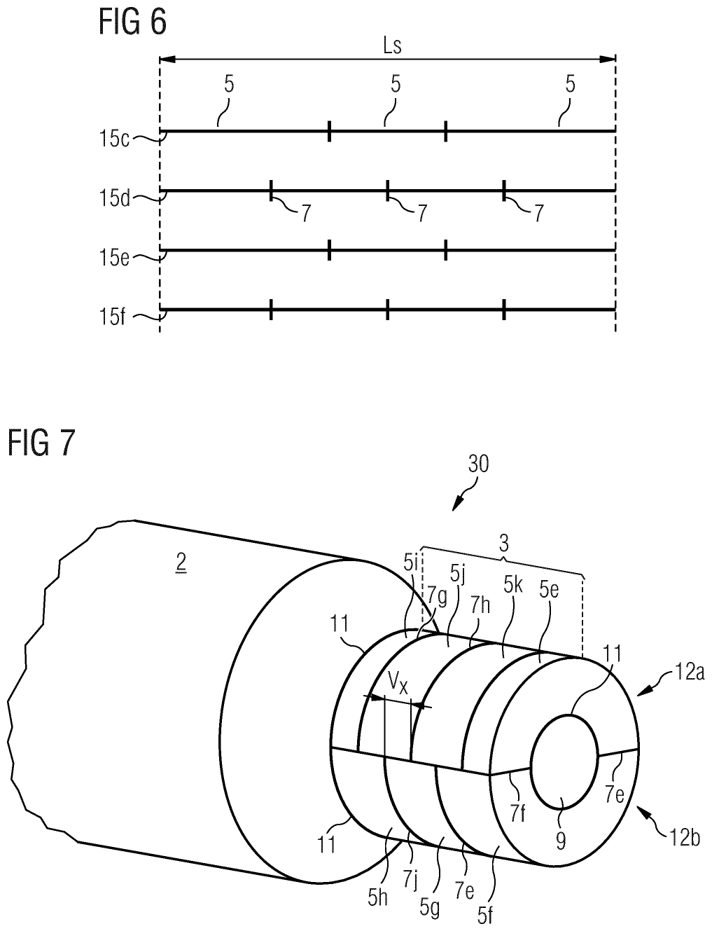

FIG. 6 shows a schematic view of the four tool cutting edges 15 shown in FIG. 5. The four tool cutting edges 15c-15f, which are disposed around the axis of rotation R of the cutting head blank, are shown in FIG. 6 in unrolled form from left to right and are plotted one above the other. The tool cutting lengths Ls shown in FIG. 6 are respectively the lengths of the tool cutting edges 15c-15f from the end of the cutting head 6 that is connected to the tool shank 2 to the terminal end of the cutting head 6. The tool cutting lengths Ls of the four tool cutting edges 15c-15f are equally long.

Furthermore, FIG. 6. shows, for each of the four tool cutting edges 15c-15f, which are depicted in unrolled form, at (along) which length of the tool cutting edges 15c-15f an abutment surface 7 is located, i.e. at (along) which points/lengths the tool cutting edges extend over from one cutting head blank element 5 to another cutting head blank element 5. The abutment surfaces 7 of the tool cutting edges 15c and 15e are located at equal lengths. The abutment surfaces 7 of the tool cutting edges 15d and 15f are located at equal lengths. But the abutment surfaces 7 of the tool cutting edges 15c and 15e are located at different lengths along the tool cutting edge as compared to the tool cutting edges 15d and 15f. Accordingly, the abutment surfaces 7 of the tool cutting edges 15c and 15e are disposed in an offset manner from the abutment surfaces 7 of the tool cutting edges 15d and 15f.

FIG. 7 is a perspective view from obliquely in front of the tool blank 30 shown in FIGS. 3 to 5. The cutting head blank elements 5e, 5i, 5j, 5k extend in the first stacked column 12a in the direction of the axis of rotation R and parallel to a second stacked column 12b that is formed by the cutting head blank elements 5f, 5g, 5h. The cutting head blank elements 5e, 5f, 5g, 5h, 5i, 5j, 5k are stacked on each other in a stacking structure. They abut against each other at abutment surfaces 7, of which abutment surfaces 7g, 7h, 7j are shown in an exemplary manner. Furthermore, abutment surfaces of cutting head blank elements abutting each other in a direction perpendicular to the axis of rotation R are shown in an exemplary manner as abutment surfaces 7e, 7f.

Because the cutting head blank elements 5e, 5f, 5g, 5h, 5i, 5j, 5k are disposed offset to each other in the direction of the axis of rotation R, for example, the abutment surface 7j does not directly border the abutment surfaces 7g or 7h.

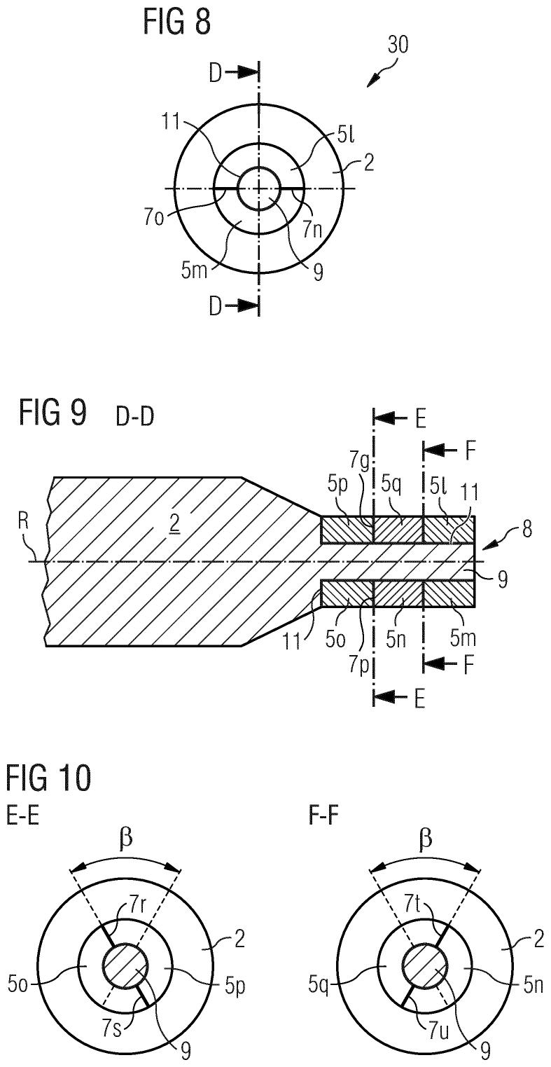

FIG. 8 shows a front view of a tool blank 30 according to the present teachings in accordance with a second embodiment.

A pin 9 is attached to the tool shank 2. Two cutting head blank elements 5l, 5m are disposed on the pin 9 one above the other. The cutting head blank elements 5l, 5m abut together at the abutment surfaces 7n and 7o and are connected together there. Moreover, the cutting head blank elements 5l, 5m are connected to the pin 9 of the tool shank 2 at the shank joint 11.

FIG. 9 is a sectional view of the tool blank 30 shown in FIG. 8 along the section D-D shown in FIG. 8. The pin 9 of the tool shank 2 extends in the direction of the axis of rotation R and in a bore 8 that passes through six cutting head blank elements 5l, 5m, 5n, 5o, 5p, 5q. The cutting head blank elements 5l, 5m, 5n, 5o, 5p, 5q abut against each other at abutment surfaces 7, of which abutment surfaces 7p, 7q are shown in an exemplary manner in FIG. 9. At the shank joint 11, the cutting head blank elements 5l, 5m, 5n, 5o, 5p, 5q are connected to the tool shank 2 or to the pin 9 of the tool shank 2. The cutting head blank elements 5l, 5m, 5n, 5o, 5p, 5q are disposed in the direction of the axis of rotation R without an offset V.

FIG. 10 shows two sectional views of the tool blank 30 shown in FIG. 9 along sections E-E and F-F shown in FIG. 9. Section E-E shows end faces of cutting head blank elements 5o, 5p. Section F-F shows end faces of cutting head blank elements 5n, 5q.

In the section E-E shown on the left, the abutment surfaces 7r and 7s between the two cutting head blank elements 5o and 5p can be seen. Further, the abutment surfaces 7t and 7u between the two cutting head blank elements 5n and 5q are shown in dashed line, as shown in the section F-F shown on the right. Conversely, the abutment surfaces 7r and 7s, which are depicted in the section E-E, are shown in dashed line in the section F-F shown on the right. The abutment surfaces 7r and 7s are disposed at a rotational offset angle β with respect to the abutment surfaces 7t and 7u.

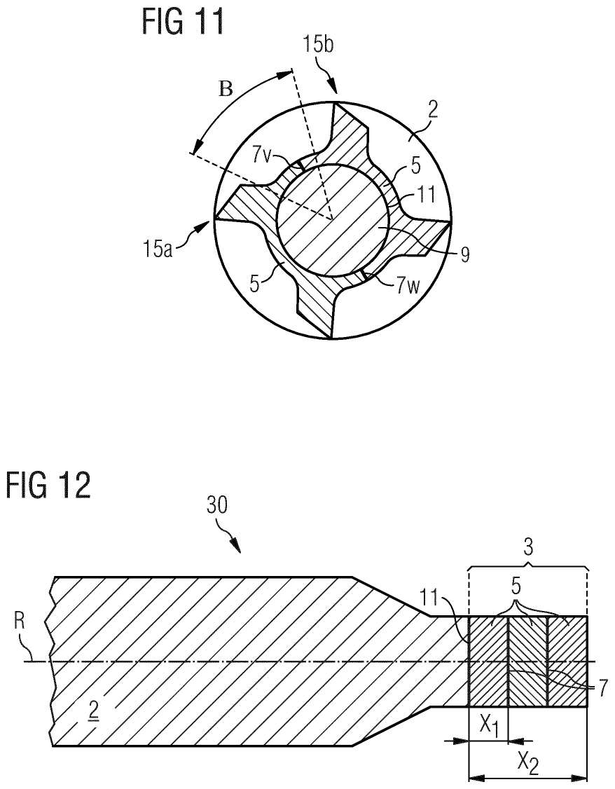

FIG. 11 is a sectional view of another exemplary embodiment of a cutting tool perpendicular to the axis of rotation R. Two cutting head blank elements 5 are connected to each other at two abutment surfaces 7v, 7w. Furthermore, the cutting head blank elements 5 are connected to the pin 9 of the tool shank 2 at the pin joint 11. Two tool cutting edges 15 are disposed on the outer circumference of each of the cutting head blank elements 5, of which the tool cutting edges 15a and 15b are shown in an exemplary manner. The abutment surface 7v extends between the tool cutting edges 15a and 15b. In addition, an area B is shown that lies between the tool cutting edges 15a and 15b and is spaced apart from the tool cutting edges 15a and 15b. This area identifies an area in which the abutment surface 7v is disposed. The same applies to the areas lying between the other tool cutting edges, which are not indicated in FIG. 11. Accordingly, the joints in these areas are also disposed at a distance (spaced apart) from the tool cutting edges.

FIG. 12 to FIG. 17 show further exemplary embodiments of tool blanks according to the present teachings.

FIG. 12 shows the sectional view of an exemplary fourth embodiment. In FIG. 12, the cutting head blank 3 is formed by the stack structure of three cutting head blank elements 5. The cutting head blank elements 5 have a height (length) x1 that is measured in the direction of the axis of rotation R. The cutting head blank 3 has a length (height) x2 that is measured in the direction of the axis of rotation R.

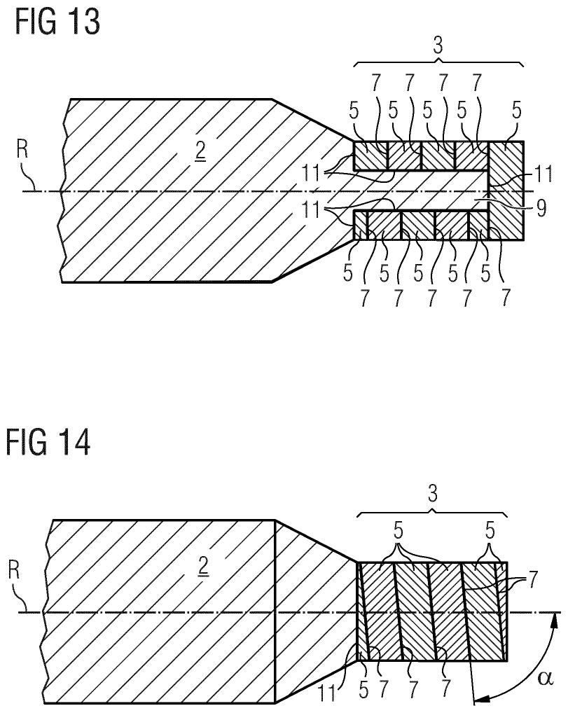

FIG. 13 shows the sectional view of an exemplary fifth embodiment. In FIG. 13, the cutting head blank 3 is formed by the stacked structure of ten cutting head blank elements 5. Nine cutting head blank elements 5 are attached from above and below, respectively, to the pin 9 of the tool shank 2, and the abutment surfaces (joints) 7 of these nine cutting head blank elements 5 have an offset V in the direction of the axis of rotation R. On the far right, a cutting head blank element 5 is additionally attached as an ending to the end face of the pin 9. Such an embodiment is suitable, in particular, for end-cutting and forming tools.

FIG. 14 shows the sectional view of an exemplary sixth embodiment. In FIG. 14, the cutting head blank 3 is formed by the stack structure of six cutting head blank elements 5. The abutment surfaces 7 between the cutting head blank elements 5 are not perpendicular to the axis of rotation R, but rather are disposed inclined at an angle α with respect to the axis of rotation R.

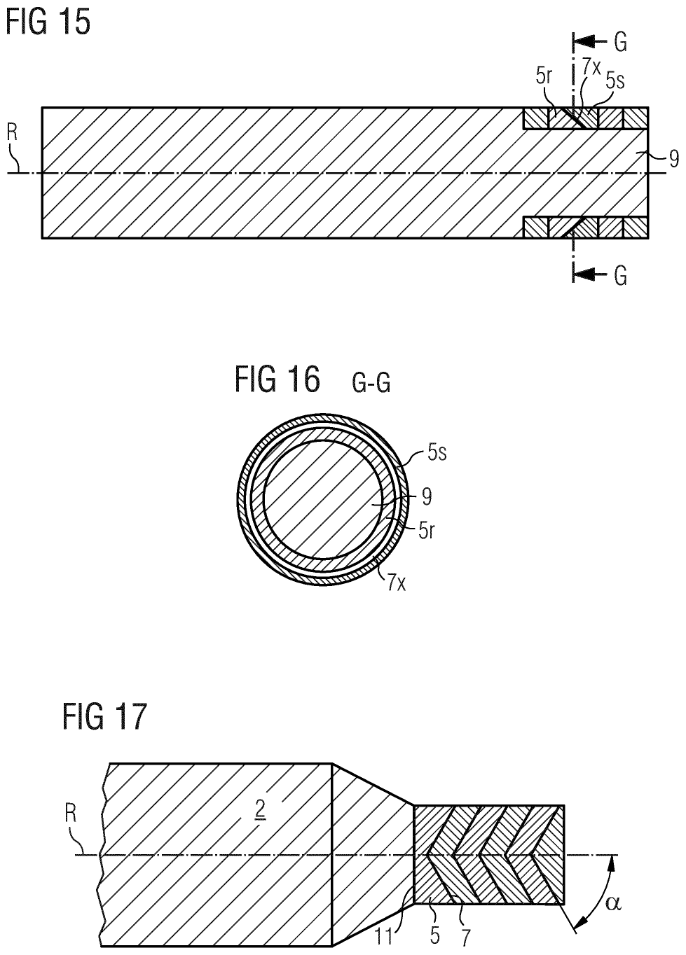

FIG. 15 shows the sectional view of an exemplary seventh embodiment having five cutting head blank elements 5 disposed on a pin 9. The abutment surface 7x between the cutting head blank elements 5r and 5s is not at a right angle to the axis of rotation R.

FIG. 16 shows a sectional view of the tool blank shown in FIG. 15 along section G-G shown in FIG. 15.

FIG. 17 is a sectional view of a tool blank according to the present teachings in accordance with an eighth embodiment. In FIG. 17, the cutting head blank 3 is formed by the stack structure of six cutting head blank elements 5. The abutment surfaces 7 between the cutting head blank elements 5 are not at right angles to the axis of rotation R, but rather are disposed at an angle α oblique with respect to the axis of rotation. In contrast to the embodiment shown in FIG. 14, the abutment surface is additionally angled such that it extends outwardly symmetrically with respect to the axis of rotation R as seen in sectional view from the axis of rotation R. The abutment surface 7 thus forms a tip in the region of the axis of rotation R, which is form-fit connected with an oppositely-shaped recess of the adjacent cutting head blank element 5.

In addition, as shown in FIG. 15, a pin and a bore can be provided in the cutting head blank elements 5. Such a pin and bore are not shown in FIG. 17.

### INDUSTRIAL APPLICABILITY

Cutting tools according to the present teachings make it possible to produce from small cutting head blank elements a proportionally larger cutting head blank or a larger cutting head having a long tool cutting edge. Such a large cutting tool is not subject to the disproportionate cost increase with volume as it is known, for example, with PCD blanks. For this reason, cutting tools having high wear resistance, great process reliability and long tool life, as well as cutting tools having large cutting heads, can be fabricated at lower cost using the present teachings.

Referring now to FIG. 7 and FIG. 1, an exemplary manufacturing process for a cutting tool is described in detail as follows.

The cutting head blank elements 5 are attached one after the other to the pin 9 of the tool shank 2 shown in FIG. 7. For this purpose, for example, the cutting head blank element 5i is first attached to the pin 9 such that it is connected to the tool shank 2 at the shank joint 11. The shank joint 11 here refers both to the connection with the section of the tool shank 2 that extends perpendicular to the axis of rotation and to the connection with the pin 9. One after another, the other cutting head blank elements 5 are attached to the pin 9. The cutting head blank elements 5 are connected to each other at the abutment surfaces 7, for example, by a solder connection. In this way, a cutting head blank 3 is created as shown in FIG. 7. The cutting head blank is composed of a total of seven cutting head blank elements 5. At least one tool cutting edge 15 is then produced (e.g., machined, cut) on this cutting head blank 3. A cutting head 6 is created thereby. For example, a cutting head 6 as depicted in FIG. 1 results. The tool cutting edges 15 extend over a plurality of the cutting head blank elements 5.

### List Of Reference Signs

1 Cutting tool
2 Tool shank
3 Cutting head blank
5, 5a-5q Cutting head blank element
6 Cutting head
7, 7a-7u Abutment surface
8 Bore, through hole
9 Pin
11 Shank joint
12, 12a, 12b Stacked column
15 Tool cutting edge
30 Tool blank
R Axis of rotation
A Angle of inclination
β Rotational offset angle
V Offset
x1 Height of the cutting head blank
x2 Length of the cutting head
L1 Element-cylinder height, element-half-cylinder height
L2 Blank-cylinder height

1. A tool blank for a cutting tool, including:
a tool shank configured to be received in a rotating tool holder of a processing machine, and
a cutting head blank fixedly connected to the tool shank, the cutting head blank comprising multiple cutting head blank elements that are fixedly connected to one another, and are made of a high-hardness material having a hardness (HV) in the range of 2000-10000 kg/mm².

2. The tool blank according to claim 1, wherein the multiple cutting head blank elements are stacked on each other in multiple stacked columns that extend in parallel in the direction of an axis of rotation (R) of the tool blank and are disposed around the axis of rotation (R).

3. The tool blank according to claim 2, wherein a first one of the cutting head blank elements in one a first one of the multiple stacked columns is disposed in an offset manner with respect to an adjacent second one of the cutting head blank elements in a second one of the multiple stacked columns with an offset in the direction of the axis of rotation (R).

4. The tool blank according to claim 3, wherein the offset V is in the range of 20% to 80% of a height (x1), which is measured in the direction of the axis of rotation, of the first one of the cutting head blank elements or of the second one of the cutting head blank elements.

5. The tool blank according to claim 2, wherein a third one of the cutting head blank elements in a first one of the multiple stacked columns is disposed at a rotational offset angle (β) about the axis of rotation (R) with respect to an adjacent fourth one of cutting head blank elements of the first stacked column.

6. The tool blank according to claim 5, wherein the rotational offset angle (β) is in the range of 10° to 80°.

7. The tool blank according to claim 1 having two stacked columns, wherein the cutting head blank elements each have a semi-cylindrical shape and are disposed such that the cutting head blank has a cylindrical shape.

8. The tool blank according to claim 1, wherein;
the multiple cutting head blank elements are disposed in a single stacked column and have a cylindrical shape, and
adjacent ones of the cutting head blank elements of the single stacked column abut against each other at respective abutment surfaces and are connected to each other at these abutment surfaces.

9. The tool blank according to claim 1, wherein at least one abutment surface between two of the cutting head blank elements, which abut on each other in the direction of an axis of rotation (R) of the tool blank, has an angle of inclination (α) with respect to the axis of rotation (R) in the range of 75°-89° in at least regionally region of the tool blank.

10. The tool blank according to claim 1, further comprising a pin projecting from an end face of the tool shank to which the cutting head blank is attached, wherein a bore or recess is formed in at least one of the cutting head blank elements such that the at least one of the cutting head blank elements having the bore or recess is attached to the pin of the tool shank in a form-fit manner.

11. The tool blank according to claim 1, wherein:
the cutting head blank elements each have a height (x1), which is measured in the direction of an axis of rotation of the tool blank, in the range from 0.2 mm to 2 mm, in particular in the range from about 0.5 mm to 1.5 mm, and
the cutting head blank has a length (x2), which is measured in the direction of the axis of rotation, in the range from 0.2 mm to 15 mm, in particular in the range from about 2 mm to 10 mm.

12. A cutting tool, wherein at least one tool cutting edge, which extends across a plurality of the fixedly interconnected cutting head blank elements, have been machined on the tool blank according to claim 1.

13. The cutting tool according to claim 12, wherein the at least one tool cutting edge does not contact an abutment surface between cutting head blank elements of different stacked columns.

14. A method for manufacturing a cutting head blank for a cutting tool including:
providing multiple prefabricated cutting head blank elements made of a high-hardness material,
fixedly connecting the multiple cutting head blank elements to each other and to a tool shank such that the interconnected cutting head blank elements form a cutting head blank that is fixedly connected to the tool shank.

15. The method according to claim 14, wherein the step of fixedly connecting the multiple cutting head blank elements to each other and to the tool shank is performed by first connecting the cutting head blank elements to form the cutting head blank and then connecting the cutting head blank to the tool shank.

16. The method according to claim 14, wherein the step of fixedly connecting the multiple cutting head blank elements to each other and to the tool shank is performed by piece by piece connecting individual ones of the cutting head blank elements to the tool shank or to a cutting head blank element that is already connected to the tool shank.

17. A method for manufacturing a cutting tool, including:
providing the cutting head blank according to claim 14, and
machining at least one tool cutting edge on the cutting head blank such that the at least one cutting edge extends across multiple ones of the cutting head blank elements.

18. The tool blank according to claim 1, wherein the multiple cutting head blank elements are fixedly connected to one another by solder.

19. The tool blank according to claim 1, wherein the high-hardness material is polycrystalline diamond.

20. The method according to claim 14, wherein the multiple prefabricated cutting head blank elements are polycrystalline diamond blanks.

21. The method according to claim 17, wherein the cutting tool is an end mill, drill or engraving tool.
